(19) United States
(12) Patent Application Publication
(10) Pub. No.: US 2025/0212035 A1
(43) Pub. Date: Jun. 26, 2025

(54) METHODS AND MODULES FOR WIDE LOCAL AREA NETWORK SENSING USING MULTI BAND DEVICES

(71) Applicant: HUAWEI TECHNOLOGIES CO., LTD., Shenzhen (CN)

(72) Inventors: Michael Peter Montemurro, Toronto (CA); Stephen McCann, Kanata (CA); Yan Xin, Kanata (CA); Jung Hoon Suh, Kanata (CA); Osama Aboul-Magd, Kanata (CA); Kwok Shum Au, Kanata (CA)

(21) Appl. No.: 18/395,829

(22) Filed: Dec. 26, 2023

(51) Int. Cl. H04W 24/10; H04W 72/0453; H04W 72/51; H04W 76/10; H04W 84/12

(52) U.S. Cl. CPC H04W 24/10; H04W 72/0453; H04W 72/51; H04W 76/10; H04W 84/12

(57) ABSTRACT

The present disclosure relates to devices for sensing applications, specifically, methods and modules wherein a first frequency band is used for communicating sensing measurements and a second frequency band is used for performing sensing functions and the second frequency band is higher than the first frequency band. The higher frequency of the second frequency band provides improved sensing function while the lower frequency of the first frequency provide improved communication characteristics. Methods and modules may relate to communications links of affiliated stations (STAs) of multi-link devices (MLDs).

### TECHNICAL FIELD

The present disclosure relates generally to multi-link devices on wireless networks, and in particular, to using communication links of multi-link devices for sensing.

### BACKGROUND

Components of a wireless local area network (WLAN) may be used for sensing, which may generally include detecting and interpreting the motion and presence of targets. WLAN systems for sensing may be directed towards functions relating to features, targets and environments such objects. More specifically, features may include range, velocity, angular orientation, movement, presence, proximity, gestures, and/or the like of objects. Targets may include human persons, animals, objects, and/or the like. Environments may include rooms, houses, buildings, vehicles, enterprises, and/or the like.

WLAN systems for sensing may generally use a frequency or range of frequencies to performing sensing functions. The use of a lower frequency may provide a longer range of communication but a lower resolution of sensing, while the use of a higher frequency may provide a higher resolution of sensing but a shorter range of communication, and may require directional communication.

### SUMMARY

The present disclosure relates to devices for sensing applications, specifically, methods and modules wherein a first frequency band is used for communicating sensing measurements and a second frequency band is used for performing a sensing function and the second frequency band is higher than the first frequency band. The higher frequency of the second frequency band provides improved sensing function while the lower frequency of the first frequency provide improved communication characteristics. Methods and modules may relate to communications links of affiliated stations (STAs) of multi-link devices (MLDs).

In a broad aspect of the present disclosure, a method comprises: communicating control messages over a first frequency band; performing sensing measurements over a second frequency band; and sending sensing measurement reports over the first frequency band, wherein the first frequency band and the second frequency band are non-overlapping and the first frequency band is lower than the second frequency band.

In some embodiments, the method comprises performing sensing measurements over the second frequency band comprises performing sensing measurements with one or more sensing devices.

In some embodiments, the method comprises establishing a first communication link with an initiating device for communicating control messages over the first frequency band; and establishing a second communication link with the initiating device for performing sensing measurements over the second frequency band.

In some embodiments, the method comprises performing sensing measurements over the first communication link.

In some embodiments, the method comprises sending sensing measurement reports over the second communication link.

In some embodiments, the first communication link is further for protocol exchanges for one or more of protected directional multi gigabit (DMG) sensing measurement request, response, report and termination; sensing by proxy DMG request, response, report and termination; and establishing and terminating millimeter wave (mmWave) links.

In some embodiments, the second communication link is further for protocol exchanges for one or more of: messages during sounding; and null data packets and long training fields.

In some embodiments, the method comprises advertising DMG sensing capability.

In some embodiments, the first communication link is further for communicating DMG management frames.

In some embodiments, the first frequency band is below 7 gigahertz (GHz) and the second frequency band is between 42 GHz and 71 GHz.

In some embodiments, the control messages and sensing measurements are for a network using an IEEE 802.11bf protocol.

In another broad aspect of the present disclosure, a module comprises: a first frequency band transceiver for communicating control messages and sending sensing measurement reports over a first frequency band; and a second frequency band transceiver for performing sensing measurements over a second frequency band, wherein the first frequency band and the second frequency band are non-overlapping and the first frequency band is lower than the second frequency band.

In some embodiments, the second frequency band transceiver is for performing sensing measurements with one or more sensing devices.

In some embodiments, the first frequency band transceiver is a first affiliated station of an MLD, and the second frequency band transceiver is a second affiliated station of an MLD.

In some embodiments, the second affiliated station is for sending sensing measurement reports.

In some embodiments, the first affiliated station is further for protocol exchanges for one or more of protected DMG sensing measurement request, response, report and termination; sensing by proxy DMG request, response, report and termination; and establishing and terminating mmWave links.

In some embodiments, the second affiliated station is further for protocol exchanges for one or more of messages during sounding; and null data packets and long training fields.

In some embodiments, the first frequency band is below 8 GHz and the second frequency band is between 42 GHz and 71 GHz.

In some embodiments, the MLD is for use in a network using an IEEE 802.11bf protocol.

In another broad aspect of the present disclosure, a module comprises a third frequency band transceiver for communicating control messages and receiving sensing measurement reports.

In some embodiments, the module comprises a fourth frequency band transceiver, wherein the third frequency band transceiver is a third affiliated station of an MLD, and the fourth frequency radio transceiver is a fourth affiliated station of the MLD.

### BRIEF DESCRIPTION OF THE DRAWINGS

For a more complete understanding of the disclosure, reference is made to the following description and accompanying drawings, in which:

FIG. 1 is a schematic of an embodiment of a pair of multi-band devices;

FIG. 2 is a schematic of an embodiment of a pair of multi-link devices MLDs;

FIG. 3 is a schematic of layout of a sensing initiating device and sensing receiving devices on a floorplan;

FIG. 4 is an illustration of an embodiment of a sensing session message sequence;

FIG. 5 is an illustration of an embodiment of a sensing session message sequence flowchart;

FIG. 6 is a schematic of an embodiment of a multi-band sensing device;

FIG. 7 is a schematic of an embodiment of a sensing initiating device and a sensing responding device in a monostatic configuration;

FIG. 8 is an illustration of an embodiment of a sensing session message sequence flow of the configuration of FIG. 7;

FIG. 9 is a schematic of an embodiment of a sensing initiating device and a sensing responding device in a bi-static configuration;

FIG. 10 is an illustration of an embodiment of a sensing session message sequence flow of the configuration of FIG. 9;

FIG. 11 is a schematic of an embodiment of a sensing topology using multi-link devices;

FIG. 12 is an illustration of an embodiment of a sensing session message sequence flow of the configuration of FIG. 11;

FIG. 13 is an illustration of an embodiment of a sensing element format;

FIG. 14 is an illustration of an embodiment of a sensing sub-field format of the sensing element format of FIG. 13; and

FIG. 15 is a flowchart of a method of an embodiment of the present disclosure.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

In embodiments disclosed herein, an access point (AP) or wireless AP is a device which acts a portal to other devices to connect to one or more other networks. In some embodiments, the AP provides an interconnection between wireless devices and other wireless/wired networks including the devices thereon. APs are commonly used for extending wireless coverage of an existing network and for increasing the number of users or devices that can connect to a wireless local area network (WLAN).

In embodiments disclosed herein, a station (STA) is a device configured to connect to others STAs and/or one or more APs. A STA may be fixed, mobile or portable. A STA may also be referred to as a wireless client, a node, and/or a transmitter or receiver based on transmission characteristics. A station management entity (SME) may be used to coordinate or control one or more STAs.

Multi-link devices (MLDs) are network elements that communicate with peer MLDs over multiple communication links. An MLD that provides AP functionality is commonly referred to as an AP MLD. A non-AP MLD uses affiliated STAs for communication over a wireless medium with other non-AP MLDs or an AP MLD. An MLD can support multiple radios operating simultaneously, each radio operating within one or more frequency bands. MLDs can establish a connection with other MLDs across multiple radios with each connection referred to as a communication link.

The Institute of Electrical and Electronics Engineers (IEEE) is a professional association for electronic and electrical engineering, and is a body responsible for setting communication standards. The IEEE 802.11 standards are a part of IEEE 802 local area network technical standards specifying media access control (MAC) and physical layer (PHY) protocols for implementing WLANs. IEEE 802.11-2020 specifies that a STA is any device that contains an IEEE 802.11-conformant MAC and PHY interface for connecting to a wireless medium.

WLAN standards, such as IEEE 802.11, can be configured for modules including MLDs to be used in a variety of modes of operation including where a module or MLD may operate in a multi-link operation (MLO) mode wherein devices communicate over multiple, independent radio connections or communication links. Communications over a single communication link occurs between affiliated STAs of modules or MLDs.

In embodiments disclosed herein, a network comprises two or more devices that are interconnected through a communication link (by a cable, a wireless connection and/or other means) for sharing resources, information, and/or the like. In embodiments disclosed herein, a module or MLD is a device that connects to one or more devices through two or more communication links. In embodiments disclosed herein, a multi-link network is a network comprising one or more MLDs.

“Affiliated” as used herein means a device, component, element and/or the like that is either physically connected to and/or integrated with, or logically connected to another device, component, element and/or the like. As used herein, an affiliated AP may be physically, logically or otherwise connected to or used by another MLD, and a reference to an affiliated AP would be equivalent to an AP being affiliated with another MLD. Similarly, as used herein, an affiliated STA may be physically, logically or otherwise connected to or used by an MLD, and a reference to an affiliated STA would be equivalent to a STA being affiliated with an MLD. In embodiments disclosed herein, an MLD may also be referred to as a multi-link device.

In embodiments disclosed herein, modules or MLDs support multiple radios simultaneously operating within multiple bands. Modules or MLDs may establish connections across multiple radios, which are referred to as communication links. Communications over a single communication link can occur between STAs affiliated with an MLD.

Embodiments disclosed herein relate to modules, systems, methods, and MLD modules, including circuitry and software for executing processes. As will be described later in more detail, a “module” is a term of explanation referring to a hardware structure such as a circuitry implemented using technologies such as electrical and/or optical technologies (and with more specific examples of semiconductors) for performing defined operations or processes.

A “module” may alternatively refer to the combination of a hardware structure and a software structure, wherein the hardware structure may be implemented using technologies such as electrical and/or optical technologies (and with more specific examples of semiconductors) in a general manner for performing defined operations or processes according to the software structure in the form of a set of instructions stored in one or more non-transitory, computer-readable storage devices or media.

A device, system, module, or MLD may be referred to as initiating where it initiates a sensing configuration, operation, process, sequence, and/or the like. A device, system, module, or MLD may be referred to as responding where it receives the message, signal, instruction, and/or the like from the initiating device, system, module, or MLD for sensing.

As will be described in more detail below, a module or MLD module may be a part of a device, an apparatus, a system, and/or the like, wherein the module or MLD module may be coupled to or integrated with other parts of the device, apparatus, or system such that the combination thereof forms the device, apparatus, or system. Alternatively, the module or MLD module may be implemented as a standalone encryption/decryption device or apparatus.

The module or MLD module executes processes including those for WLAN sensing. Herein, a process has a general meaning equivalent to that of a method, and does not necessarily correspond to the concept of computing process (which is the instance of a computer program being executed). More specifically, a process herein is a defined method implemented using hardware components for processing data (for example, transmitting and receiving management frames, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the processes disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as random access memory (RAM), read-only memory (ROM), electrically-erasable programmable read-only memory (EEPROM), solid-state memory devices, hard disks, compact discs (CDs), digital video discs (DVDs), flash memory devices, and/or the like. The module or MLD module may read the computer-executable code from the storage devices and execute the computer-executable code to perform the encryption and/or decryption processes.

Alternatively, the module or processes disclosed herein may be implemented as one or more hardware structures having necessary electrical and/or optical components, circuits, logic gates, integrated circuit (IC) chips, and/or the like.

In some embodiments of the present disclosure, modules or MLD modules may comprise multiple radios that will support operation in a wide range of frequencies including but not limited to for IEEE 802.11 applications and within sub-7 or sub-8 GHz and millimeter wave (mmWave) bands, mmWave bands being between about 42.5 and 71 GHz. The modules or MLD modules may be suitable for use in systems for 802.11 be, which includes support for MLO at the MAC layer. While specific frequencies are referenced herein, such as sub-7 or sub-8 GHz or mmWave, modules or MLD modules described herein are suitable for other frequencies.

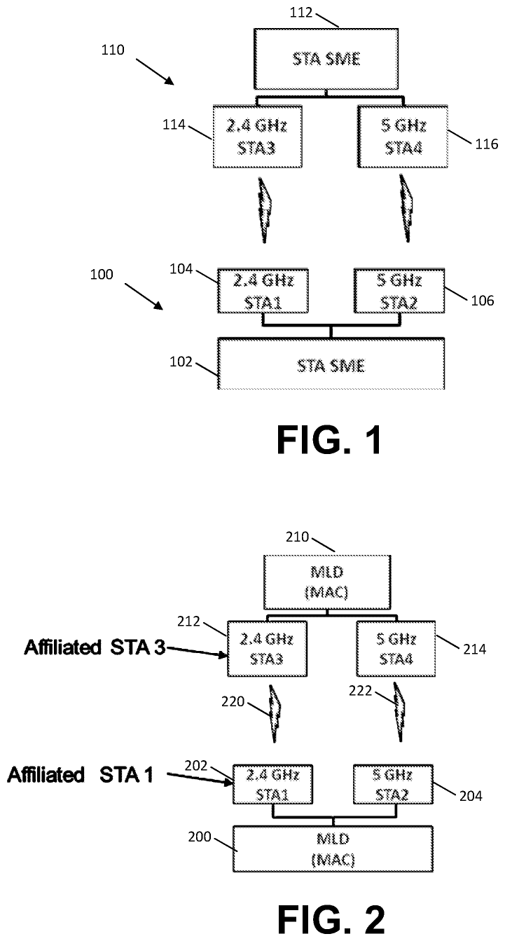

Referring to FIG. 1, in some embodiments of the present disclosure of a multi-band device, a first module 100 comprises first STA SME 102 coordinating or controlling two radios, a first STA 104 configured for communication over a sub-7 or sub-8 GHz band, such as 2.4 GHz, and a second STA 106 configured for communication over a range of frequencies in another band, such as 5 GHz. A second module 110 comprises a second STA SME 112 coordinating or controlling two radios, a third STA 114 configured for communication over a sub-7 or sub-8 GHz band, such as 2.4 GHz, and a fourth STA 116 configured for communication over a range of frequencies in another band, such as 5 GHz.

Referring to FIG. 2, in some embodiments of the present disclosure of an MLD, a first MLD module 200 comprises two radios, a first STA 202 configured for communication over a sub-7 or sub-8 GHz band, such as 2.4 GHz, and a second STA 204 configured for communication over a range of frequencies in another band, such as 5 GHz. A second MLD module 210 comprises two radios, a third STA 212 configured for communication over a sub-7 or sub-8 GHz band, such as 2.4 GHz, and a fourth STA 114 configured for communication over a range of frequencies in another band, such as 5 GHz. The first MLD module 200 and the second MLD module 210 are connected, the first STA 202 and the third STA 212 are connected forming a first link 220, and the second STA 204 and the fourth STA 214 are connected forming a second link 222. In multi-band operation, the first MLD module 200 and the second MLD module 210 may communicate using either or both of the first link 220 and the second link 222. In MLO, communication between the first MLD module 200 and the second MLD module 210 may be aggregated across multiple links 220 and 222 through affiliated STAs (the first STA 202 and the third STA 212 at 2.4 GHz and the second STA 204 and the fourth STA 214 at 5 GHz).

IEEE 802.11bf comprises an extension standard for IEEE 802.11 relating to enabling 802.11 devices to support WLAN sensing. WLAN sensing comprises the use of a device, such as a module or MLD module, comprising one or more STAs configured for sensing for receiving signals to detect one or more features or one or more intended targets in a variety of environments for different applications, such as for intruder detection in security applications, fall detection in human safety applications, and gesture recognition in voice and video communications applications. Sensing may relate to different features, targets, and environments. Features of a potential target may include range, velocity, angular position or movement, motion, presence or proximity, gestures, and/or the like. Targets may be objects, humans, animals, and/or the like. Environments may include rooms, houses, buildings, vehicles, enterprises, and/or the like. In some embodiments, channel state information (CSI) may be used in 802.11 to support beam forming and CSI may be used as an input to sensing applications.

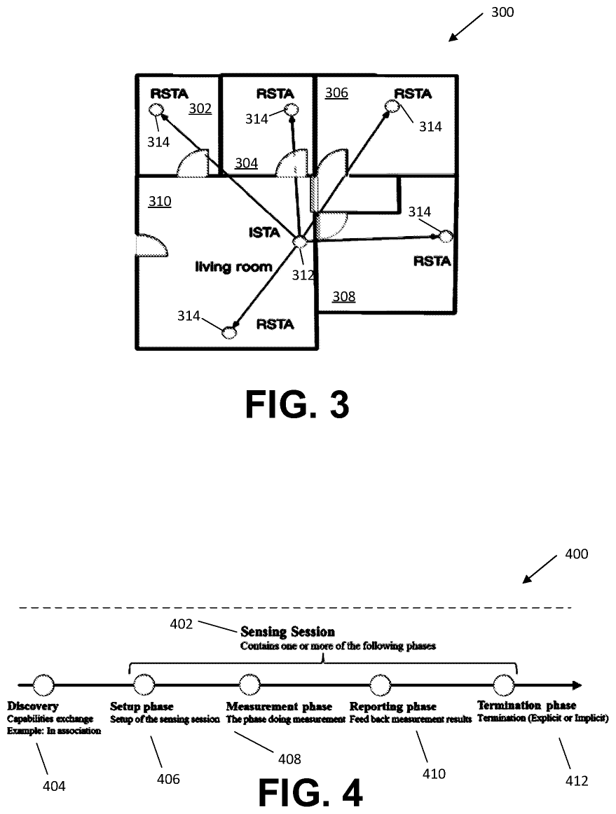

Referring to FIG. 3, an exemplary house environment 300 comprises a first room 302, a second room 304, a third room 306, a fourth room 308, and a fifth room or living room 310. An initiating STA (ISTA) is located in the fifth room 310, while a receiving STA (RSTA) is located in each of the first room 302, the second room 304, the third room 306, the fourth room 308, and the fifth room 310. An ISTA may be for transmitting protocol packet data units (PPDUs) used for sensing measurements while a RSTA may be for receiving PPDUs originating from the ISTA. The RSTA may be further for performing sensing measurements. The combination of the ISTA and the RSTAs may be for sensing features and targets in the exemplary house environment 300. Different applications may have different characteristics of CSI. For example, for intruder detection, sensing may require regular CSI feedback. CSI feedback over a particular period of time may be highly correlated.

Embodiments of the present disclosure may be suitable for operation with any frequency ranges suitable for sensing applications. For example, IEEE 802.11bf comprises protocols for sensing using sub-7 or sub-8 GHz frequency bands, including 2.4 GHz, 5 GHz, and 6 GHz, as well as for millimetric frequency bands, such as 45 to 60 GHz, which may also be referred to as direction multi-gigabit (DMG) and mmWave. Separate frame types may be used for sub-7 or sub-8 GHz and DMG CSI measurements. WLAN sensing using frequencies in the mmWave frequency bands may provide better sensing resolution than sub-7 or sub-8 GHz frequency bands due to using a shorter wavelength. However, communication in mmWave frequency bands generally are directional and more limited in range.

Referring to FIG. 4, in some embodiments, a sensing protocol 400, such as for IEEE 802.11bf, may comprise up to five phases. Initially, the sensing protocol 400 may comprise a discovery phase 404 wherein capabilities of devices or modules are exchanged and associations are established. The sensing protocol may further comprise a setup phase 406, a measurement phase 408, a reporting phase 410, and a termination phase 412. A sensing session 402 may comprise one or more of the setup phase 406, the measurement phase 408, the reporting phase 410, and the termination phase 412. The setup phase 406 comprises setting up a sensing session 402 and may include transmitting a threshold parameter from an initiating module to a responding module, such as in a sensing request frame. The threshold parameter may assist a receiver in determining when CSI variations indicate motion of objects. The measurement phase 408 may comprise performing measurements and calculations. The reporting phase 410 may comprise communicating or providing feedback on measurement results. The termination phase 412 may be either explicit or implicit and may be for terminating the sensing session 402.

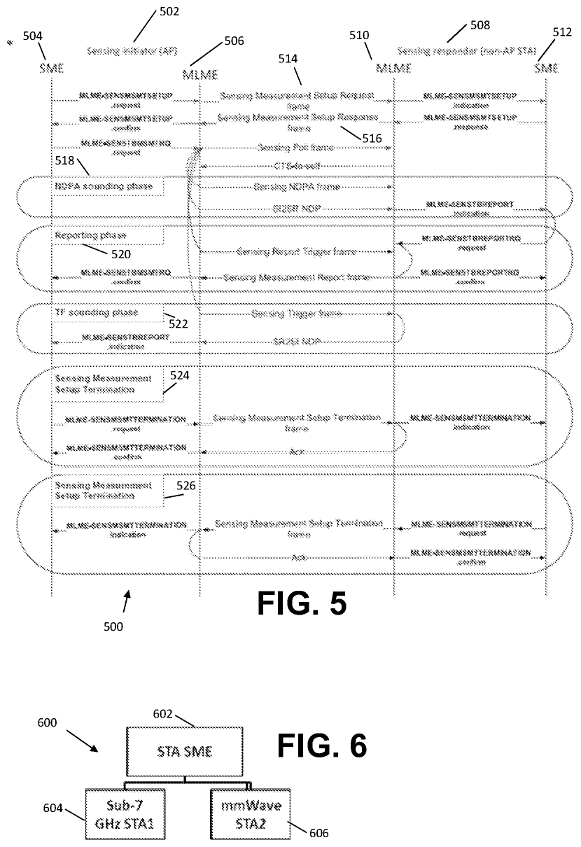

Referring to FIG. 5, in some embodiment, message flow 500 is illustrated between a sensing initiating device 502, which may be an AP, and a sensing responding device 508, which may be a non-AP STA. The sensing initiating device 502 may comprise a SME 504 and a MAC layer management entity (MLME) 506 while the sensing responding device 508 may comprise a SME 512 and a MLME 510. The initials steps of the message flow 500 may comprise transmitting a sensing measurement setup request frame 514 from the MLME 506 of the sensing initiating device 502 to the MLME 510 of the sensing responding device 508, following by transmitting a sensing measurement setup response frame 516 from the MLME 510 of the sensing responding device 508 to the MLME 506 of the sensing initiating device 502. The message flow 500 may further comprise sending a null data packet frame (NDPA frame) during a NDPA sounding phase 518, a reporting phase 520, a trigger frame sounding phase 522, a sensing measurement and setup termination phase 524 and 526. Sensing mechanisms in IEEE 802.11bf may be for transmitting control and sensing data in-band with sensing measurement information.

As previously discussed, due to shorter wavelengths, communications using higher frequencies, such as within the mmWave frequency band, may have more limited range and require directional operation when compared to communications using lower frequencies, such as within the sub-7 or sub-8 GHz frequency band. However, resolution of sensing using higher frequencies, such as in the mmWave frequency ranges, are better.

Multiband or multi-link devices, having multiple STAs, are capable of operating on multiple bands simultaneously by using different STAs. In some embodiments, sensing may be performed using frequencies in the mmWave band, while control and reporting may be done using frequencies in the sub-7 or sub-8 GHz frequency band. Sensing report frames are transmitted to a sensing initiating device over sub-7 or sub-8 GHz bands. Further, if either the mmWave band or sub-7 or sub-8 GHz band fail, control and DMG report frames may be transmitted on the remaining link to ensure sensing measurements are not lost.

Referring to FIG. 6, a first module 100 comprises a STA SME 602 coordinating or controlling two radios, a first STA 604 configured for communication over a sub-7 or sub-8 GHz band, and a second STA 606 configured for to operate in a mmWave band.

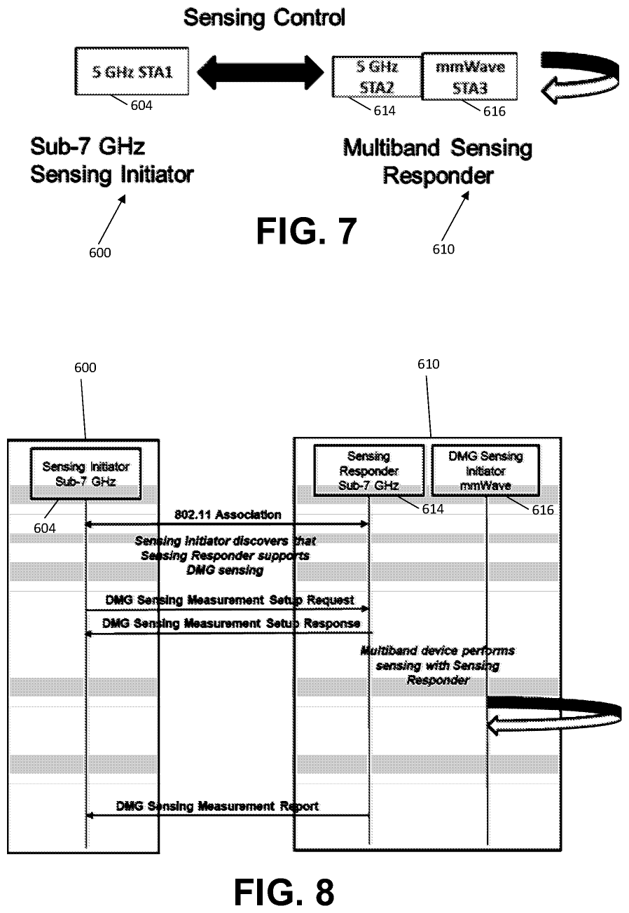

In embodiments of the present disclosure, modules may operate in a monostatic sensing configuration. Referring to FIG. 7, the first module 600 operates as a sensing initiating device and comprises a first STA 604. A second module 610, operating as a sensing responding device, comprises a second STA 614 configured for communication over a sub-7 or sub-8 GHz band and a third STA 616 configured to operate in a mmWave frequency band. The first STA 604 and the second STA 614 are for communicating sensing control and measurement reporting in a sub-7 or sub-8 GHz frequency band, which may be 5 GHz. Sensing measurements are performed by the second module 610 using the third STA 616 operating in a mmWave frequency band. An exemplary message flow is illustrated in FIG. 8, namely establishing 802.11 association between the sensing initiating device 600 and the sensing responding device 610, sending a DMG sensing measurement setup request from the sensing initiating device 600 to the sensing responding device 610, responding to the DMG measurement setup request with a DMG sensing measurement setup response from the sensing responding device 610 to the sensing initiating device 600, performing sensing by the sensing responding device, and sending a DMG sensing measurement report from the sensing responding device 610 to the sensing initiating device 600.

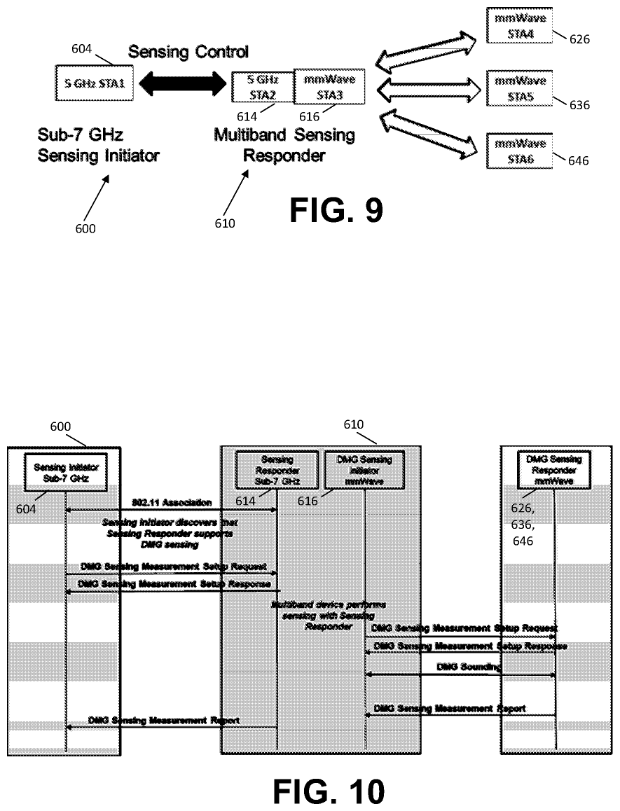

In embodiments of the present disclosure, modules may operate in a bi-static sensing configuration. Referring to FIG. 9, the first module 600 operates as a sensing initiating device and comprises a first STA 604. A second module 610, operating as a sensing responding device, comprises a second STA 614 configured for communication over a sub-7 or sub-8 GHz band and third STA 616 configured to operate in a mmWave band. In this embodiment, the system further comprises a third module comprising a fourth STA 626, a fourth module comprising a fifth STA 636, and a fifth module comprising a sixth STA 646. The fourth STA 626, the fifth STA 636, and the sixth STA 646 are configured to performing sensing measurements with the third STA 616 over a mmWave frequency band. Measurement reports from the second module 610 are communicated to the first module 600 using the second STA 614 and the first STA 604. An exemplary message flow is illustrated in FIG. 10, namely establishing 802.11 association between the sensing initiating device 600 and the sensing responding device 610, sending a DMG sensing measurement setup request from the sensing initiating device 600 to the sensing responding device 610, responding to the DMG measurement setup request with a DMG sensing measurement setup response from the sensing responding device 610 to the sensing initiating device 600, performing sensing among the second module 610, the third module, the fourth module and the fifth module, and sending a DMG sensing measurement report from the sensing responding device 610 to the sensing initiating device 600. Sensing among the second, third, fourth and fifth modules comprising sending a DMG sensing measurement setup request from the third STA 616 to one or more of the fourth STA 626, the fifth STA 636, and the sixth STA 646, responding to the DMG measurement setup request with a DMG sensing measurement setup response, DMG sounding from the third STA 616 to one or more of the fourth STA 626, the fifth STA 636, and the sixth STA 646, and sending a DMG sensing measurement report to the third STA 616.

While in embodiments of the monostatic and bi-static configurations described above, the second module 610 comprises a second STA 614 configured for communicated over a sub-7 or sub-8 GHz band, the second module 610 could not have the second STA 614 and communications could occur over the third STA 616.

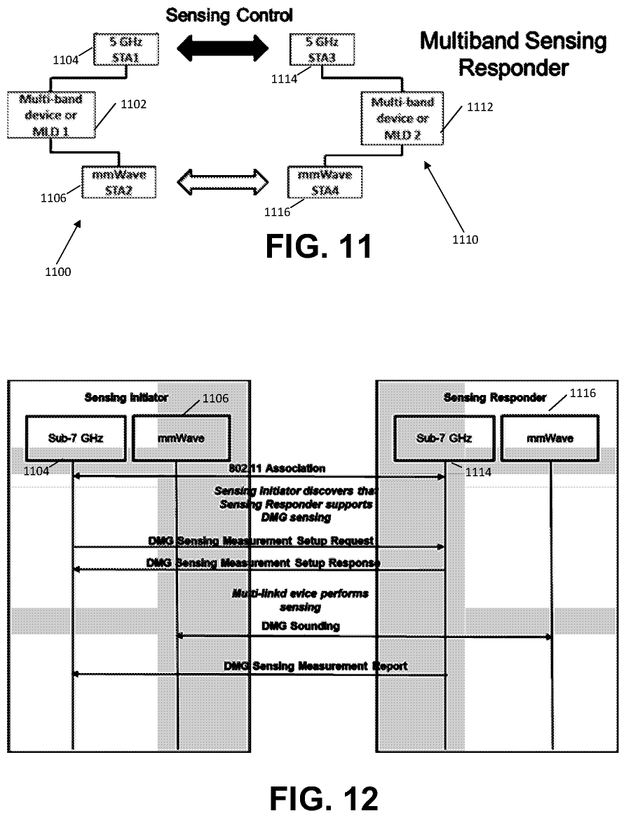

In embodiments of the present disclosure, modules may be multi-band devices or MLDs. Referring to FIG. 11, a first MLD 1100, operating as initiating device, comprises a first affiliated STA 1104 configured for communication over a sub-7 or sub-8 GHz band, such as 5 GHz, and a second affiliated STA 1106 configured to operate in a mmWave frequency band. A second MLD 1110, operating as responding device, comprises a third affiliated STA 1114 configured for communication over a sub-7 or sub-8 GHz band, such as 5 GHz, and a fourth affiliated STA 1116 configured to operate in a mmWave frequency band. The first MLD 1100 is for transmitting control messages to the second MLD 1110. The 5 GHz affiliated STAs, being the first STA 1104 and the third STA 1114, are for communicating control messages between the first MLD 1100 acting as initiating device and the second MLD 1110 acting as responding device. The mmWave affiliated STAs, being the second STA 1106 and the fourth STA 1116, are for performing sensing measurements. Measurement reports generated by the second MLD 1110 may be transmitted back to the first MLD 1100 using any available link, either the 5 GHz or mmWave link. An exemplary message flow is illustrated in FIG. 12, namely 802.11 association, the DMG sensing measurement setup request and response and the DMG sensing measurement report occurring between the first affiliated STA 1104 and the third affiliated STA 1114 at the sub-7 or sub-8 GHz frequency band, while DMG sounding occurs between the second affiliated STA 1106 and the fourth affiliated STA 1116 at the mmWave frequency band. In some embodiments, beam forming training may occur for the mmWave band.

In some embodiments, the sensing initiating device and the sensing responding device may exchange multi-link information, which may occur using the sub-7 or sub-8 GHz band. The multi-link information may comprise mmWave sensing capability and operation information. The sensing initiating device and the sensing responding device may also exchange information for DMG or enhanced directional multi-gigabit (EDMG) capability and control elements. This may occur prior to performing sensing measurements. This may occur in the sub-7 or sub-8 GHz link in addition to over the mmWave link.

Protocol exchanges that may occur over the sub-7 or sub-8 GHz link include protected DMG sensing measurement, request, response, report, and termination; sensing by proxy (SBP) protected DMG request, response, report, and termination; and messages to power up or to terminate mmWave links exclusively relating to sensing.

Protocol exchanges that may occur over the mmWave link including messages exchanged during sounding as well as null data PPDU and long training field (LTF).

In some embodiments, sensing capability may be advertised. For example, DMG sensing capability using a sub-7 or sub-8 GHz link may be advertised. The sensing initiating device may advertise information about mmWave with sub-7 or sub-8 GHz sensing capability in beacons, probe requests, access network query protocol (ANQP) request, association requests, re-association requests, and/or the like. DMG sensing capability may also be advertised by the sensing responding device about mmWave with sub-7 or sub-8 GHz sensing capability in probe requests, ANQP requests, association requests, re-association requests, and/or the like.

A sensing initiating device may send a DMG sensing measurement setup request to a sensing responding device over a sub-7 or sub-8 GHz link, which allows a non-AP STA or MLD to initiate a mmWave sensing session.

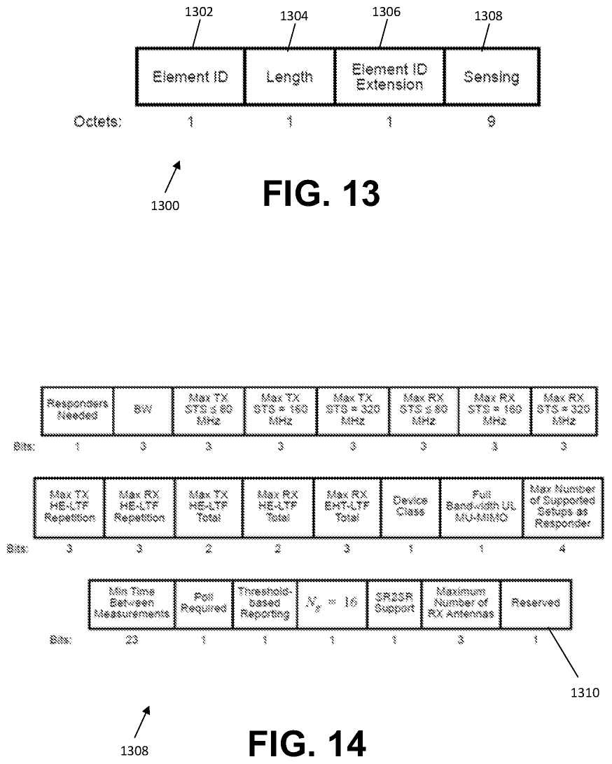

In another embodiment, a sensing initiating device may be a non-AP STA or MLD and the sensing responding device is an AP or MLD. A sensing element format 1300 for IEEE 802.11bf is illustrated in FIG. 13. The sensing element format 1300 may comprise fields for element identification 1302, length 1304, element identification extension 1306, and sensing 1308. The sensing sub-field 1308 may comprise the sub-fields as illustrated in FIG. 14 including a reserved bit 1310. In some embodiments, the reserved bit 1310 may be used as a DMG sensing bit, wherein when the bit is set to 1, the MLD has sub-7 or sub-8 GHz and mmWave links capable of multi-band sensing. Conversely, when the bit is set to 0, the MLD does not have multi-band sensing capability. This may also apply to configurations of MLDs where all of its links are sub-7 or sub-8 GHz and/or where all of the links are mmWave.

DMG management frame include frames for measurement requests, responses, and termination. The DMG management frames may be transmitted over a sub-7 or sub-8 GHz link. New behavior may be defined so that the receiver knows that a received DMG report frame (on a sub-7 or sub-8 GHz band) is for another link (such as a mmWave band link). An identifier (Link ID) for the other link may be attached to existing DMG management frames as an extension.

A suitable Link ID info field may be provided by a 1 octet field in IEEE 802.11be to indicate mmWave sensing controlled over a sub-7 or sub-8 GHz link, mmWave sensing reports transmitted to initiating device over sub-7 or sub-8 GHz link, a requirement that at least one responding device has multi-band or multi-link capability, the responding device is multi-band capable, the initiating device does not require mmWave capability, the initiating device does not require a line-of-sight environment, the initiating device does not require beam-forming training, and/or the like.

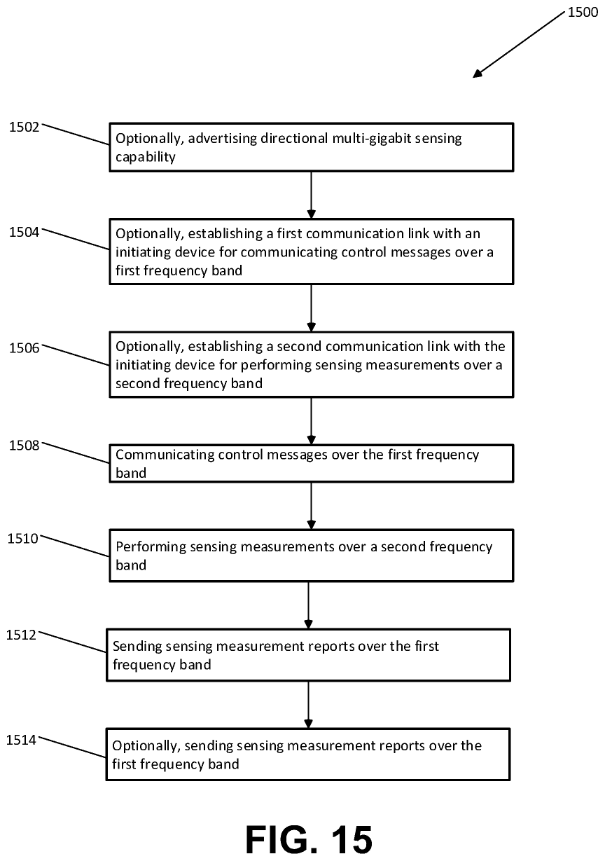

FIG. 15 is a flowchart showing steps of a method 1500, according to one embodiment of the present disclosure. The method 1500 begins with, optionally, advertising DMG sensing capability (step 1502). At step 1504, optionally, a first communication link is established with an initiating device for communicating control messages over a first frequency band. At step 1506, optionally, a second communication link is established with an initiating device for performing sensing measurements over a second frequency band. At step 1508, control messages are communicated over the first frequency band. At step 1510, sensing measurements are performed over a second frequency band. At step 1512, sensing measurement reports are sent over the first frequency band. At step 1514, optionally, sensing measurement reports are sent over the first frequency band.

Although embodiments have been described above with reference to the accompanying drawings, those of skill in the art will appreciate that variations and modifications may be made without departing from the scope thereof as defined by the appended claims.

1. A method comprising:
communicating control messages over a first frequency band;
performing sensing measurements over a second frequency band; and
sending sensing measurement reports over the first frequency band,
wherein the first frequency band and the second frequency band are non-overlapping and the first frequency band is lower than the second frequency band.

2. The method of claim 1, wherein performing sensing measurements over the second frequency band comprises performing sensing measurements with one or more sensing devices.

3. The method of claim 1 further comprising:
establishing a first communication link with an initiating device for communicating control messages over the first frequency band; and
establishing a second communication link with the initiating device for performing sensing measurements over the second frequency band.

4. The method of claim 3 further comprising sending sensing measurement reports over the second communication link.

5. The method of claim 3, wherein the first communication link is further for protocol exchanges for one or more of:
protected directional multi gigabit (DMG) sensing measurement request, response, report and termination;
sensing by proxy DMG request, response, report and termination; and
establishing and terminating millimeter wave (mmWave) links.

6. The method of claim 3, wherein the second communication link is further for protocol exchanges for one or more of:
messages during sounding; and
null data packets and long training fields.

7. The method of claim 1, further comprising advertising DMG sensing capability.

8. The method of claim 3, wherein the first communication link is further for communicating DMG management frames.

9. The method of claim 1, wherein the first frequency band is below 8 gigahertz (GHz) and the second frequency band is between 42 GHz and 71 GHz.

10. The method of claim 1, wherein the control messages and sensing measurements are for a network using an IEEE 802.11bf protocol.

11. A module comprising:
a first frequency band transceiver for communicating control messages and sending sensing measurement reports over a first frequency band; and
a second frequency band transceiver for performing sensing measurements over a second frequency band,
wherein the first frequency band and the second frequency band are non-overlapping and the first frequency band is lower than the second frequency band.

12. The module of claim 11, wherein the second frequency band transceiver is for performing sensing measurements with one or more sensing devices.

13. The module of claim 11, wherein the first frequency band transceiver is a first affiliated station of an MLD, and the second frequency band transceiver is a second affiliated station of an MLD.

14. The module of claim 13, wherein the second affiliated station is for sending sensing measurement reports.

15. The module of claim 13, wherein the first affiliated station is further for protocol exchanges for one or more of:
protected DMG sensing measurement request, response, report and termination;
sensing by proxy DMG request, response, report and termination; and
establishing and terminating mmWave links.

16. The module of claim 13, wherein the second affiliated station is further for protocol exchanges for one or more of:
messages during sounding; and
null data packets and long training fields.

17. The module of claim 11, wherein the first frequency band is below 7 GHz and the second frequency band is between 42 GHz and 71 GHz.

18. The module of claim 13, wherein the MLD is for a network using an IEEE 802.11bf protocol.

19. A module comprising a third frequency band transceiver for communicating control messages and receiving sensing measurement reports.

20. The module of claim 19 further comprising a fourth frequency band transceiver, wherein the third frequency band transceiver is a third affiliated station of an MLD, and the fourth frequency radio transceiver is a fourth affiliated station of the MLD.
